(19) United States
(12) Patent Application Publication
(10) Pub. No.: US 2005/0219624 A1
(43) Pub. Date: Oct. 6, 2005

(54) Device and method for controlling image forming apparatus

(76) Inventor: Alexei Zavitaev, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/025,856

(22) Filed: Dec. 30, 2004

(30) Foreign Application Priority Data
Jan. 9, 2004 (KR) 10-2004-0001422

(51) Int. Cl. H04N 1/405

(52) U.S. Cl. 358/3.06

(57) ABSTRACT

A control device of an image forming apparatus which processes print object page data in parallel and does not require a display list. The control device includes a raster graphics processor which includes a vector graphics unit and a halftoning unit, a decomposer which interprets print object page data and which relays a raster image to the halftoning unit, and a buffer memory which temporarily stores outputs of the vector graphics unit and the halftoning unit. In the control device, the vector graphics unit, the halftoning unit, and the decomposer each operate in parallel.

### CROSS-REFERENCE TO RELATED APPLICATIONS

This application claims the benefit under 35 U.S.C. §119(a) of Korean Patent Application No. 2004-1422, filed in the Korean Intellectual Property Office on Jan. 9, 2004, the entire contents of which are hereby incorporated by reference.

### BACKGROUND OF THE INVENTION

1. Field of the Invention

The present invention relates to a device and method for controlling an image forming apparatus. More particularly, the present invention relates to a device and method for controlling an image forming apparatus applied to a laser printer and composer, and the like, wherein printing data is processed in parallel.

2. Description of the Related Art

Printers of conventional image forming apparatuses can be categorized as general printers or window version window graphics device interface (GDI) printers, which provide an independent (that is, independent from a device) graphics function for a relevant device when expressing an image in a window environment. General printers include printer control language (PCL) printers, developed by Hewlett Packard Corp., and postscript (PS) printers, developed by Adobe Corp.

FIG. 1 illustrates an embodiment of a printing system for printing data, composed by computer on an image forming apparatus (that is, a printer).

Referring to FIG. 1, when the user of a computer 1 wants to print a print object document using a printer 5, a printer driver 3 receives data that is to be printed using an application program 2. An operating system (OS) enables the printer driver 3 to receive the print data. When the printer driver 3 receives the print data, the printer driver 3 composes an image of the print data such that it is suitable for printing. After the printer driver 3 composes image data suitable for the printer 5, the printer driver 3 transmits the image data to the printer 5 through a parallel port 4.

When the print data transmitted from the computer 1 is received at the printer 5 through the parallel port 4, a printer controller 6 interprets the transmitted print data thereby forming an image, and then transmits the data to a printer engine 8 that performs the printing using any number of methods. For example, in a transfer photograph process method, the printer engine 8 prints an image to a recording medium by a process of photoresist electrification, laser exposure, developing, and transferring. Reference number 7 in FIG. 1 denotes a control panel through which these, and other various functions can be selected.

In contrast, the laser printer, which is another type of image forming apparatus, manages the print data according to a full page buffering method or a band buffering method. The full page buffering managing method allocates a frame buffer at once that corresponds to one page, directly interprets the data input to the printer, and starts printing when one page is filled while unraveling the data into the frame buffer in a bit map form. As an example, to print a one-page A4 document, a 1 MB frame buffer is needed. The full page buffering method has a disadvantage of requiring a large amount of memory, and also of not being able to process the data of the next page before the previous page is completely printed.

The band buffering managing method does not allocate a frame buffer at once which corresponds to one page, but allocates buffers to a few physical bands forming an image to be printed, and performs printing by transmitting the image to the printer engine. According to this method, the printer engine prints and simultaneously, an image is created in the physical bands. Specifically, the control device of the printer interprets the data which corresponds to one band that is input by a computer as shown in step S52 of FIG. 2. FIG. 2 is a flowchart illustrating an operation of the printing system of FIG. 1. The control device then converts the data into a command form which can be made into a bitmap within the shortest time in step S54, and stores it in a band buffer. The command stored in the band buffer is interpreted by a command processing means at step S58 after the printer engine is driven at step S56, and is converted into a bitmap image at step S60. The converted bitmap image is then printed by the printer engine in real time at step S62.

Band buffering and related art are disclosed in a U.S. Pat. No. 6,621,586 entitled “Accurately Scheduling Rendering Of Bands In A Printer”, issued Sep. 16, 2003 to Kumar et al., the entire contents of which are incorporated herein by reference.

In contrast, the control device of an image forming apparatus, such as a laser printer, has a structure like that shown in FIG. 3. In general, the control device includes a main central processing unit 10, a raster graphics processor (RGP) 20, and a printer engine video controller (PVC) 30. The main central processing unit 10 includes a data inputting unit 12, a decomposer 14, a display list 16, and a buffer memory 18. Reference number 40 in FIG. 3 indicates a printer engine.

As described above, conventional print object page data can be divided into bands of identical sizes. The decomposer 14 interprets, or analyzes, data transmitted from the data inputting unit 12 and converts it into commands, such as raster graphics processor type commands. The commands which are converted by the decomposer 14, are then input and preserved in the display list 16. When all data input from the data inputting unit 12 is processed in the decomposer 14, the display list 16 transmits the preserved command list to the raster graphics processor 20. Each command includes various corresponding bands.

However, in the conventional control devices of the image forming apparatus, the decomposer and the raster graphics processor process data according to a series method, therefore, the overall processing speed of the image forming apparatus is relatively slow. Accordingly, a need exists for a system and method for processing print object page data at a higher speed.

### SUMMARY OF THE INVENTION

The present invention provides a control device of an image forming apparatus and a method thereof, for processing print object page data at a high speed by processing the print object page data in parallel.

The present invention also provides a control device of an image forming apparatus which does not require a display list, and further includes a raster graphics processor including a halftoning unit and a vector graphics unit.

According to another aspect of the present invention, a device is provided for controlling an image forming apparatus. The device includes a raster graphics processor which includes a vector graphics unit and a halftoning unit, a decomposer which interprets print object page data, relays a raster image to the halftoning unit, and relays vector graphics to the vector graphics unit, and a buffer memory which temporarily stores outputs of the vector graphics unit, the halftoning unit, and the decomposer. In this case, the vector graphics unit, the halftoning unit, and the decomposer operate in parallel.

The decomposer and the memory buffer may be included in a main central processing unit (CPU), and the memory buffer may include a dynamic random access memory (DRAM).

The main CPU may further include a data inputting unit for receiving the print object page data as input data.

The halftoning unit and the vector graphics unit each may also have an internal queue.

The decomposer may interpret the data input into the data inputting unit and convert it into a command that the raster graphics processor can understand.

When the processing of page data related to each of the vector graphics unit, the halftoning unit, and the decomposer is completed, the data of the buffer memory may then be transmitted to a printer engine video controller and may be output in print from the printer engine.

According to another aspect of the present invention, a method is provided for controlling an image forming apparatus, such that a vector graphics unit and halftoning unit included in a Raster graphics processor, and a decomposer which interprets print object page data, relays a raster image to the halftoning unit, and relays vector graphics to the vector graphics unit, all operate in parallel.

### BRIEF DESCRIPTION OF THE DRAWINGS

The above and other features and advantages of the present invention will become more apparent by describing in detail an exemplary embodiment thereof with reference to the attached drawings in which:

FIG. 1 is a block diagram of a conventional printing system;

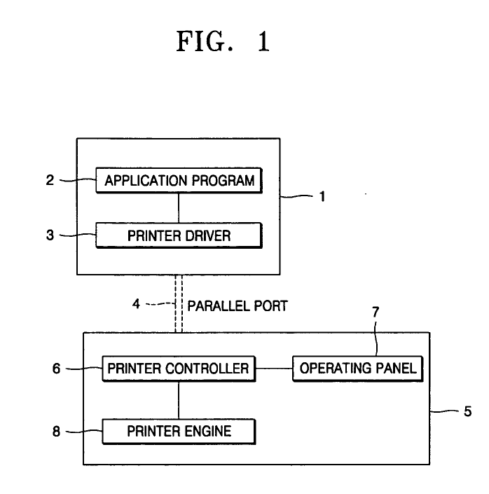

FIG. 2 is a flowchart illustrating an operation of the printing system of FIG. 1;

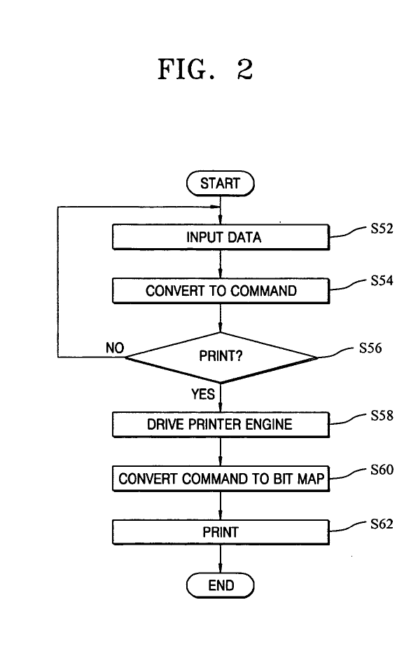

FIG. 3 is a block diagram of an exemplary structure of a control device of a conventional image forming apparatus; and

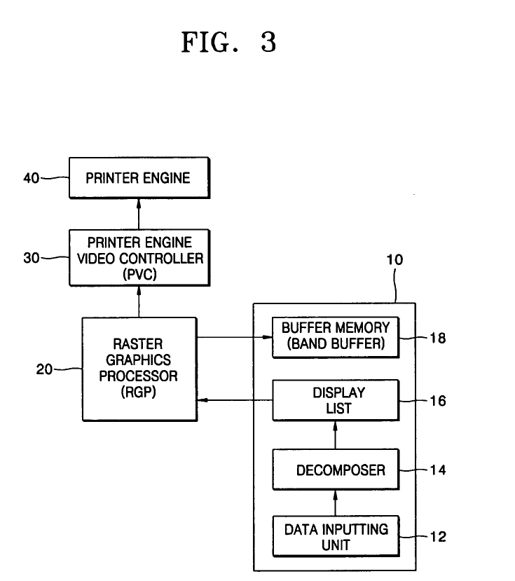

FIG. 4 is a block diagram of an exemplary structure of a control device of an image forming apparatus according to an embodiment of the present invention.

Throughout the drawings, like reference numerals will be understood to refer to like parts, components and structures.

### DETAILED DESCRIPTION OF THE EXEMPLARY EMBODIMENTS

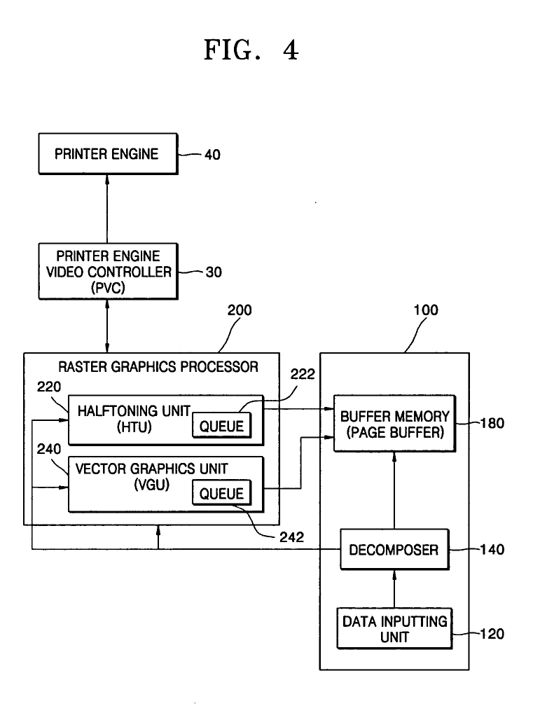

FIG. 4 is a block diagram of an exemplary structure of a control device of an image forming apparatus according to an embodiment of the present invention.

Referring to FIG. 4, a decomposer 140 is directly connected to a raster graphics processor 200 to parallel process page data, and a halftoning unit 220 and a vector graphics unit 240 are each directly connected to a buffer memory 180 of a main central processing device 100. The vector graphics unit 240 and halftoning unit 220 are included in the raster graphics processor 200. The main central processing device 100 as illustrated in FIG. 4 includes a data inputting unit 120 which receives input printer control language (PCL) page data, postscript (PS) page data and other such data, the decomposer 140, and the buffer memory 180.

The raster graphics processor 200 is connected to a printer engine video controller 30 which is connected to a printer engine 40.

The control device of the image forming apparatus having the structure shown in FIG. 4 and a method by which it functions according to an embodiment of the present invention, is described in greater detail below.

When page data of an object that is to be printed is sent to the decomposer 140 from the data inputting unit 120, the decomposer 140 interprets the page data, sends a raster image of the page data to the halftoning unit 220, and sends vector graphics of the page data to a vector graphics unit 240. In addition, the decomposer converts the data sent from the data inputting unit 120 into commands understood by the raster graphics processor 200, such as a coordinate adjusting command and a font download command.

The main central processing unit 100, the halftoning unit 220, and the vector graphics unit 240 all operate in parallel. The output data of the decomposer 140, the halftoning unit 220, and the vector graphics unit 240 are temporarily stored in a page buffer, that is, a buffer memory 180. Preferably, the buffer memory 180 is a dynamic random access memory (DRAM).

When the decomposer 140, the halftoning unit 220, and the vector graphics unit 240 have each processed the related page data, the buffer memory 180 transmits the stored data to the printer engine video controller 30. When the data is transmitted from the buffer memory 180, the printer engine video controller 30 converts the data into image data that can be output in print by the printer engine 40, and transmits the image data to the printer engine 40. When the image data is transmitted to the printer engine 40, the printer engine 40 outputs the image data in print to a recording medium.

The halftoning unit 220 converts a grayscale image, an RGB image, and a CMYK image and the like, into a 1-bit plane, such as for a monochrome printer. The raster graphics processor 200 directly adds the 1-bit plane to the buffer memory 180. In the halftoning process, the greatest amount of time is spent printing pages. Therefore, the ability in the present invention to process other data while performing halftoning increases processing speed.

The vector graphics unit 240 is provided to manage the vector graphics command, that is, rasterization, and to fill in polygons, lines, circles, and the like. It is well-known in the art that rasterization refers to converting the vector graphics to corresponding pixel pattern images.

The halftoning unit 220 and the vector graphics unit 240, further include internal queues 222 and 242, respectively, so that the decomposer 140 can put in requests and continue working. The halftoning unit 220 and the vector graphics unit 240 obtain comments from the queues 222 and 242, manage the comments, and output the results to the buffer memory 180.

As described above, when the halftoning unit 220, vector graphics unit 240, and decomposer 140 and the like, have each finished their tasks, the buffer memory 180 transmits the stored data to the printer engine video controller 30 so that it is then output in print by the printer engine 40.

The present invention processes the input page data in parallel, thereby increasing the processing speed of the image forming apparatus.

In addition, the present invention includes a raster graphics processor which includes a halftoning unit and a vector graphics unit, and increases the processing speed of the image forming apparatus since there is no need for a display list.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A device for controlling an image forming apparatus, comprising:
a raster graphics processor which includes a vector graphics unit and a halftoning unit;
a decomposer which interprets print object page data, relays a raster image to the halftoning unit, and relays vector graphics to the vector graphics unit; and
a memory buffer which temporarily stores outputs of the vector graphics unit, the halftoning unit, and the decomposer,
wherein, the vector graphics unit, the halftoning unit, and the decomposer operate in parallel.

2. The device of claim 1, further comprising a main central processing unit (CPU) including the decomposer and the memory buffer.

3. The device of claim 1, wherein the memory buffer comprises a dynamic random access memory (DRAM).

4. The device of claim 2, wherein the main CPU further comprises a data inputting unit for receiving the print object page data.

5. The device of claim 1, wherein the halftoning unit and the vector graphics unit each comprise an internal queue.

6. The device of claim 4, wherein the decomposer interprets the data input into the data inputting unit and converts it into a command that the raster graphics processor can understand.

7. The device of claim 1, further comprising:
a printer engine video controller for receiving the data of the buffer memory and for outputting the data in print from a printer engine when a processing of page data related to each of the vector graphics unit, the halftoning unit, and the decomposer is completed.

8. A method for controlling an image forming apparatus, comprising the steps of:
operating a vector graphics unit and a halftoning unit included in a Raster graphics processor; and
operating a decomposer to interpret print object page data, relay a raster image to the halftoning unit, and relay vector graphics to the vector graphics unit,
wherein the vector graphics unit, halftoning unit and decomposer all operate in parallel.
